(19) United States
(12) Patent Application Publication
(10) Pub. No.: US 2026/0335167 A1
(43) Pub. Date: Oct. 29, 2026

(54) JOINT DEVICE AND WEARABLE ROBOT INCLUDING THE SAME

(71) Applicants: HYUNDAI MOTOR COMPANY, Seocho-gu (KR); Kia Corporation, Seocho-gu (KR)

(72) Inventors: Neung Hwan YIM, Gyeonggido (KR); Ho Jun KIM, Gyeonggido (KR); Taek Seong JIN, Gyeonggido (KR); Hyeon Su KIM, Gyeonggido (KR); Ki Pyeong YU, Gyeonggido (KR); Hyun Seop LIM, Gyeonggido (KR); Seung Jun LEE, Gyeonggido (KR)

(21) Appl. No.: 19/415,028

(22) Filed: Dec. 10, 2025

(30) Foreign Application Priority Data
Apr. 28, 2025 (KR) 10-2025-0055687

(51) Int. Cl. A61H 3/00; A61H 1/02

(52) U.S. Cl. CPC A61H 3/00; A61H 1/024; A61H 1/0244; A61H 1/0266; A61H 2201/149

(57) ABSTRACT

A joint device including a body link, a rotary link coupled to the body link and configured to be rotatable about a rotary shaft, and an elastic rod member having a first side coupled to the body link, and a second side coupled to the rotary link, in which i) the first side of the elastic rod member is configured to be movable relative to the body link, or ii) the second side of the elastic rod member is configured to be movable relative to the rotary link.

### CROSS-REFERENCE TO RELATED APPLICATION

Pursuant to 35 U.S.C. § 119(a), this application claims the benefit of an earlier filing date and right of priority to Korean Patent Application No. 10-2025-0055687 filed in the Korean Intellectual Property Office on Apr. 28, 2025, the entire contents of which are incorporated herein by reference.

### TECHNICAL FIELD

The present disclosure generally relates to a joint device and a wearable robot including the same.

### BACKGROUND

Jointed structures include rigid links that are rotatably connected to rotate relative to each other through rotation axes. Such jointed structures are applicable to various mechanical parts, such as robots.

### SUMMARY

One aspect of the present disclosure provides a joint device including: a first link; a second link coupled to the first link and configured to be rotatable about a rotary shaft; and an elastic rod member having a first side coupled to the first link, and a second side coupled to the second link, in which the elastic rod member is configured to be elastically curved in conjunction with a rotational motion of the second link relative to the first link, and in which i) the first side of the elastic rod member is configured to be movable relative to the first link, or ii) the second side of the elastic rod member is configured to be movable relative to the second link.

The second side of the elastic rod member may be fixedly coupled to the second link, and the first side of the elastic rod member may be configured to be movable relative to the first link.

The joint device may further include: a guide member fixed to the first link and configured such that a part of the elastic rod member is inserted into the guide member, in which the elastic rod member is configured to be movable relative to the guide member which is fixed on the first link.

The joint device may further include: an elasticity adjustment member configured to be adjustably positioned on the first link and movably coupled to the elastic rod member, and configured such that a part of the elastic rod member is inserted into the elasticity adjustment member, in which the elasticity adjustment member is configured to be adjustably positioned among a plurality of positions on the first link, and is configured to allow the elastic rod member to be movable relative to the elasticity adjustment member.

The elasticity adjustment member may be adjustably positioned among the plurality of positions on the first link between (i) the first side of the elastic rod member, which is movably coupled to the first link, and (ii) the second side of the elastic rod member which is fixedly coupled to the second link.

The elastic rod member may be provided as a plurality of elastic rod members disposed in parallel.

The elasticity adjustment member may be provided as a plurality of elasticity adjustment members, and the plurality of elasticity adjustment members may be provided to be spaced apart from one another in a longitudinal direction of the elastic rod member.

The joint device may further include: a locking member provided at one side of the first link and configured to selectively allow or restrict a motion of the elastic rod member.

At least a part of the locking member may be provided in the guide member.

Another aspect of the present disclosure provides a wearable robot including: a joint device provided to face a joint of a wearer, in which the joint device includes: a body link; a rotary link coupled to the body link and configured to be rotatable about a rotary shaft A; and an elastic rod member having a first side coupled to the body link, and a second side coupled to the rotary link, in which the elastic rod member is configured to be elastically curved in conjunction with a rotational motion of the rotary link relative to the body link, and in which i) the first side of the elastic rod member is configured to be movable relative to the body link, or ii) the second side of the elastic rod member is configured to be movable relative to the rotary link.

The rotary shaft A may be provided to face an ankle joint of the wearer, the body link may be provided to face a leg side of the wearer based on the rotary shaft A, and the rotary link may be provided to face a foot side of the wearer based on the rotary shaft A.

The rotary shaft A may be provided to face a knee joint of the wearer, the body link may be provided to face a thigh side of the wearer based on the rotary shaft A, and the rotary link may be provided to face a calf side of the wearer based on the rotary shaft A.

The rotary shaft A may be provided to face a hip joint of the wearer, the body link may be provided to face an upper body side of the wearer based on the rotary shaft A, and the rotary link may be provided to face a lower body side of the wearer based on the rotary shaft A.

According to the present disclosure, the joint device, to which the elastic bar structure is applied, may create various elastic force profiles.

### BRIEF DESCRIPTION OF THE DRAWINGS

FIG. 1 is a side view of an example of a joint device according to the present disclosure.

FIG. 2 is a view illustrating an example of a first state in which a rotary link of the joint device according to the present disclosure is rotated.

FIG. 3 is a view illustrating an example of a second state in which elasticity of an elastic rod member is adjusted by a movement of an elasticity adjustment member in FIG. 2.

FIG. 4 is a view schematically illustrating an example of a wearable robot structure to which the joint device according to the present disclosure is applied in case that the joint device is used to assist an ankle joint of a wearer.

FIG. 5 is a view schematically illustrating an example of the wearable robot structure to which the joint device according to the present disclosure is applied in case that the joint device is used to assist a knee joint of a wearer.

FIG. 6 is a view schematically illustrating an example of the wearable robot structure to which the joint device according to the present disclosure is applied in case that the joint device is used to assist a hip joint of a wearer.

### DETAILED DESCRIPTION

Jointed structures can include an elastic component that provides an elastic force, for example, to provide a restoring force against a rotational motion of the jointed structure and also to absorb impact applied by a motion of the jointed structure. Examples of such elastic components that provide the elastic force can include a torsion spring, a tensile/compression spring, and an elastic bar structure using an elastic force of a material.

However, in scenarios where a torsion spring is used to provide an elastic force, a thickness of the torsion spring needs to be increased to ensure a high elastic modulus while maintaining a large maximum rotation angle of the link. This can create a problem in increasing an overall thickness of the joint structure and adversely affecting durability of the torsion spring in case that the link rotates in the opposite directions. In addition, scenarios that use a tensile/compression spring to provide the elastic force typically provide the elastic force only in one direction because of the nature of the spring, and therefore a plurality of springs are required to generate a rotational restoring force against a rotation of the link. For this reason, there can result problem in complicating the joint structure, and significantly degrading the efficiency of generating the rotational restoring force in accordance with a rotation angle of the link. In addition, in scenarios that use an elastic bar to provide the elastic force, and in particular in structures where the two opposite ends of the elastic bar are fixed to the joint structure, this may cause a problem in creating too many design constraints.

Implementations of the present disclosure can provide a joint device configured with various elastic force profiles. Hereinafter, a joint device and a wearable robot according to various implementations of the present disclosure will be described with reference to the drawings.

### JOINT DEVICE

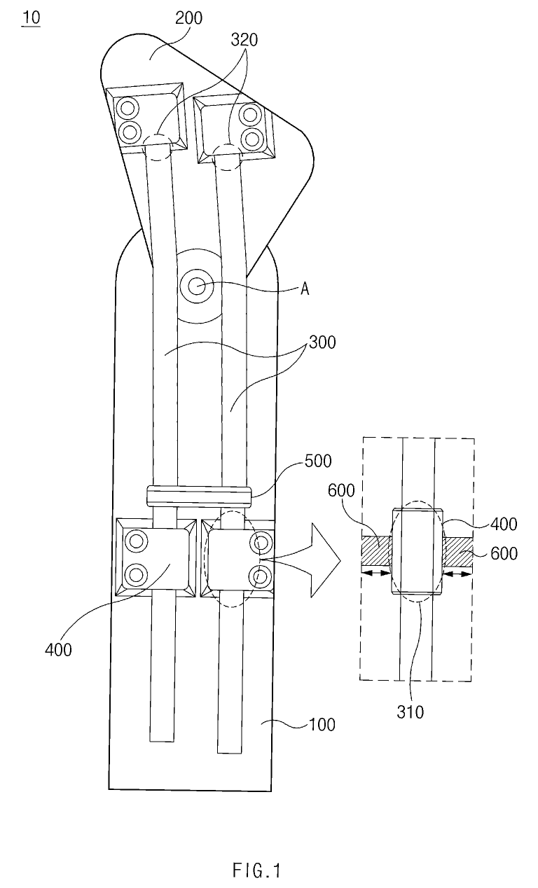

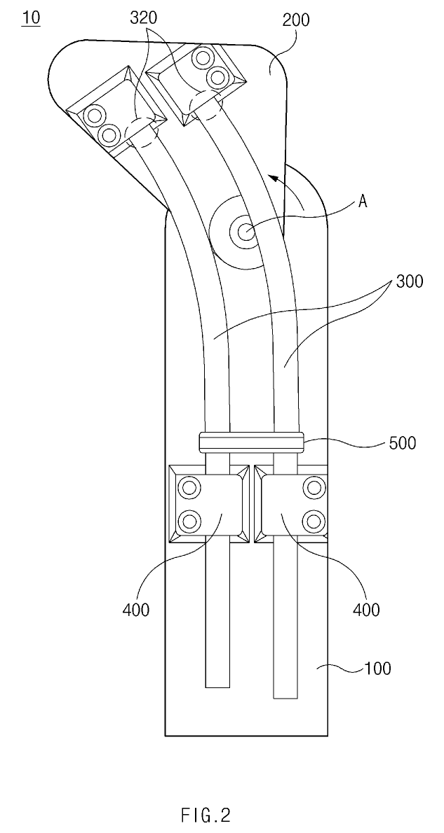

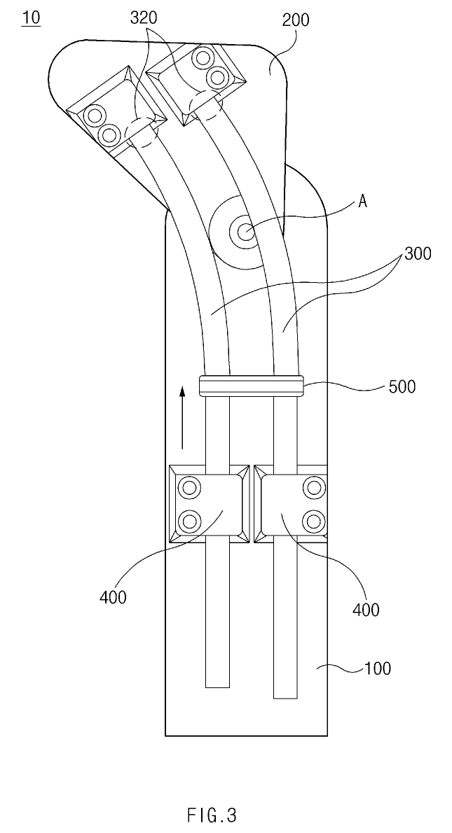

FIG. 1 is a side view of an example of a joint device according to the present disclosure, and FIG. 2 is a view illustrating an example of a first state in which a rotary link of the joint device according to the present disclosure is rotated. FIG. 3 is a view illustrating an example of a second state in which elasticity of an elastic rod member is adjusted by a movement of an elasticity adjustment member in FIG. 2.

With reference to FIGS. 1-3, a joint device 10 according to the present disclosure may include a first link such as a body link 100 and a second link such as a rotary link 200 coupled to the body link 100. The body link 100 and rotary link 200 can be configured to be rotatable with respect to each other about a rotary shaft A. The joint device 10 can also include elastic rod members 300 each having a first side 310 coupled to the body link 100, and a second side 320 coupled to the rotary link 200. The coupling of the elastic rod members 300 to the body link100 and to rotary link 200 can be a fixed coupling or a movable coupling, as described further below.

According to implementations of the present disclosure, the elastic rod member 300 may be configured to elastically curve in conjunction with a rotational motion of the rotary link 200 relative to the body link 100. In some implementations, the elastic rod member 300 may have a rod shape which can be distinguished from a configuration having a spring shape. For example, the elastic rod member 300 may be configured to generate an elastic force while being elastically curved (e.g., as in FIGS. 2 and 3), instead of being configured to generate an elastic force while being stretched or contracted in a longitudinal direction.

In addition, according to some implementations of the present disclosure, i) the elastic rod member 300 may be configured to be movable relative to the body link 100 at the first side 310 of the elastic rod member 300, or ii) the elastic rod member 300 may be configured to be movable relative to the rotary link 200 at the second side 320.

For example, as illustrated in FIG. 1, the second side 320 of the elastic rod member 300 may be fixedly coupled to the rotary link 200, and the first side 310 of the elastic rod member 300 may be configured to be movable relative to the body link 100. In such implementations, when the elastic rod member 300 elastically curves in conjunction with the rotation of the rotary link 200, the second side 320 and the rotary link 200 do not move relative to each other, whereas the first side 310 and the body link 100 may move relative to each other.

More specifically, in the above-described implementations, the first side 310 of the elastic rod member 300 may be configured to be longitudinally movable relative to the body link 100, e.g., so that the first side 310 of the elastic rod member 300 can freely slide up and down longitudinally relative to the body link 100 as the elastic rod member 300 is elastically curved. For example, the joint device 10 may further include guide members 400 into which the elastic rod members 300 are inserted. The guide member 400 may have one side fixed to the body link 100. A hole, which corresponds to a width of the elastic rod member 300, may be formed in the guide member 400, and the elastic rod member 300 may be inserted into the hole. Therefore, the elastic rod member 300 may be configured to be movable relative to the guide member 400, e.g., by freely sliding up and down longitudinally in the hole.

Through the implementations described above, the elastic rod member 300 can apply a restorative elastic force in a direction that is opposite a direction in which the rotary link 200 is rotated relative to the body link 100. The amount of the restorative elastic force applied by the elastic rod member 300 depends on the radius of curvature of the elastic rod member 300, with a smaller radius generating a larger restorative elastic force, thereby increasing the elasticity (torsion) applied to the rotating joint due to bending of the elastic rod member 300. The radius of curvature of the elastic rod member 300 depends on the distance between a first point at which the first side 310 of the elastic rod member 300 is coupled to the body link 100 and a second point at which the second side 320 of the elastic rod member 300 is coupled to the rotary link 200, with smaller distance resulting in a smaller radius of curvature. Implementations are described below for adjusting this distance, thereby adjusting the radius of curvature of the elastic rod member 300 and the amount of restorative elastic force applied by the elastic rod member 300.

With continued reference to FIGS. 1-3, the joint device 10 according to some implementations of the present disclosure may further include an elasticity adjustment member 500. The elasticity adjustment member 500 can be movably coupled to the elastic rod members 300 so that the elastic rod members 300 are inserted into the elasticity adjustment member 500.

The elasticity adjustment member 500 according to some implementations of the present disclosure may be configured to change a profile of an elastic force generated when the elastic rod member 300 is elastically curved.

To provide this ability, the elasticity adjustment member 500 may be configured to be adjustably connected to the body link 100, and may allow the elastic rod members 300 to freely move through the elasticity adjustment member 500. For example, the elasticity adjustment member 500 can be adjustably connected to the body link 100 so as to be adjustably connected at various adjustable positions on the body link 100. The elastic rod member 300 may be inserted into the elasticity adjustment member 500 to freely move relative to the elasticity adjustment member 500. Therefore, the elasticity adjustment member 500 can be adjustably connected at different longitudinal positions on the body link 100, which adjusts a distance between the elasticity adjustment member 500 and the second side 320, such that the profile of the elastic force, which is generated when the elastic rod member 300 is elastically curved, may be adjusted. For example, FIGS. 2 and 3 illustrate two scenarios with the same rotation angle of the rotary link 200 relative to the body link 100. However, in comparison with FIG. 2, it can be seen from FIG. 3 that the elasticity adjustment member 500 is adjusted to be connected to the body link 100 in a direction closer toward the rotary link 200. In this case, even in a state in which the rotation angle of the rotary link 200 relative to the body link 100 remains the same, a magnitude of the elastic force, which is generated when the elastic rod member 300 is elastically curved, may further increase in FIG. 3. In some implementations, in order for the elasticity adjustment member 500 to exhibit the above-mentioned feature, the elasticity adjustment member 500 may be adjustably connected to the body link 100 at various locations between the first side 310 and second side 320 of the elastic rod member 300.

In some implementations of the present disclosure, the elastic rod members 300 may be provided as a plurality of elastic rod members 300 disposed in parallel. For example, FIGS. 1-3 illustrate scenarios in which two elastic rod members 300 are disposed side by side in parallel with each other in the joint device 10. More particularly, according to some implementations of the present disclosure, the plurality of elastic rod members 300 may be disposed side by side regardless of a rotation angle of the rotary link 200 with respect to the body link 100.

In some implementations, the above-mentioned elasticity adjustment member 500 may be provided as a plurality of elasticity adjustment members 500. For example, the plurality of elasticity adjustment members 500 may be provided to be spaced apart from one another in a longitudinal direction of the elastic rod member 300. Such implementations can enable more precise adjustment of the elastic force profile of the elastic rod member 300.

In some implementations, as shown in FIG. 1, the joint device 10 according to the present disclosure may further include locking members 600. The locking members 600 can be provided at one side of the body link 100 and configured to selectively allow or restrict the motion of the elastic rod member 300. In the above-described implementations of the present disclosure, the elastic rod member 300 may be elastically curved in conjunction with the rotation of the rotary link 200, and thus the first side 310 of the elastic rod member 300 may freely move relative to the guide member 400. However, in some scenarios, it may be helpful to lock the first side 310 of the elastic rod member 300 to the guide member 400. For example, in scenarios where the joint device 10 should operate similar to a rigid body, as a whole, as the rotary link 200 is fixed after being rotated by a predetermined angle, it may be helpful to restrict the movement of the first side 310 of the elastic rod member 300.

As such, the locking member 600 may be configured to restrict the joint device 10 to operate similar to a rigid body. For example, at least a part of the locking member 600 may be provided in the guide member 400, and the locking member 600 may be configured to restrict movement of the elastic rod member 300 or to allow free movement of the elastic rod member 300. For example, in the locked state, the locking member 600 can be adjusted to clamp down on the elastic rod member 300 to restrict movement. In the unlocked state, the locking member 600 can be adjusted to release from the elastic rod member 300 to allow free movement. Therefore, when the locking member 600 is unlocked from the elastic rod member 300, the elastic rod member 300 may freely move relative to the guide member 400 and the locking member 600. By contrast, when the locking member 600 is locked and in contact with the elastic rod member 300, the elastic rod member 300 may be fixed relative to the guide member 400 and the locking member 600.

### WEARABLE ROBOT

The wearable robot according to implementations of the present disclosure will be described in the examples below, with reference to features described for the joint device 10, above. The description of the joint device 10 described above with reference to FIGS. 1-3 may be applied to the description of the joint device 10 provided in the wearable robot described below.

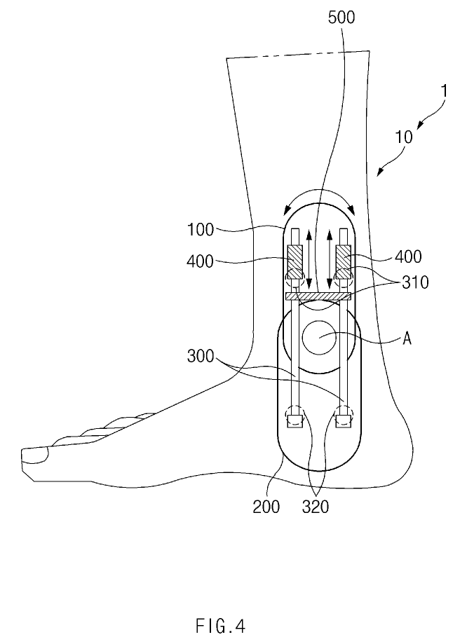

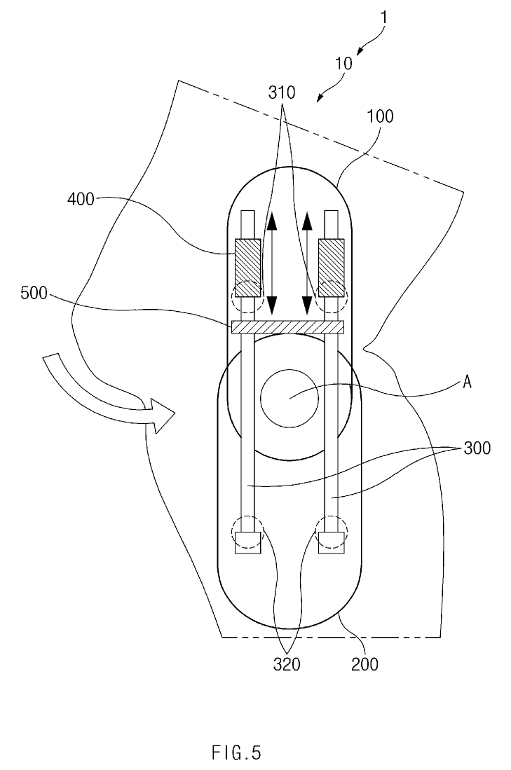

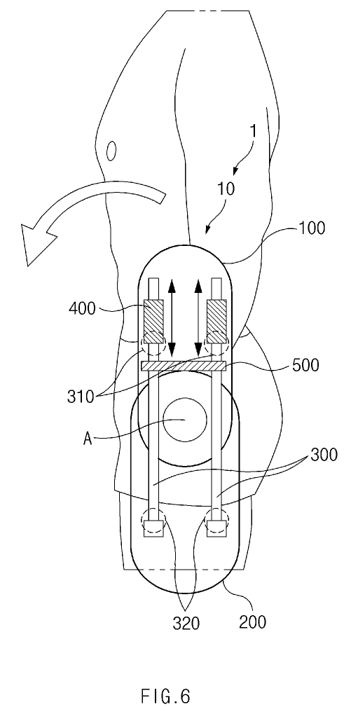

FIG. 4 is a view schematically illustrating an example of a wearable robot structure to which the joint device according to the present disclosure is applied in case that the joint device is used to assist an ankle joint of a wearer, and FIG. 5 is a view schematically illustrating an example of the wearable robot structure to which the joint device according to the present disclosure is applied in case that the joint device is used to assist a knee joint of a wearer. FIG. 6 is a view schematically illustrating an example of the wearable robot structure to which the joint device according to the present disclosure is applied in case that the joint device is used to assist a hip joint of a wearer.

A wearable robot 1 according to the present disclosure may include the joint device 10 provided to face a joint of a wearer. As described above, the joint device 10 according to the present disclosure may include the body link 100, the rotary link 200 coupled to the body link 100 and configured to be rotatable about the rotary shaft A, and the elastic rod members 300 each having the first side 310 coupled to the body link 100, and the second side 320 coupled to the rotary link 200. The elastic rod member 300 may be configured to be elastically curved in conjunction with the rotational motion of the rotary link 200 relative to the body link 100. In addition, according to some implementations of the present disclosure, i) the elastic rod member 300 may be configured to be movable relative to the body link 100 at the first side 310 of the elastic rod member 300, or ii) the elastic rod member 300 may be configured to be movable relative to the rotary link 200 at the second side 320 of the elastic rod member 300.

With reference to FIG. 4, the wearable robot 1 according to some implementations of the present disclosure may be configured to assist movement of an ankle of the wearer. In this case, the above-mentioned rotary shaft A may be provided to face the ankle joint of the wearer. In addition, the body link 100 may be provided to face a side of a leg of the wearer based on the rotary shaft A, and the rotary link 200 may be provided to face a side of a foot of the wearer based on the rotary shaft A.

In some implementations, with reference to FIG. 5, the wearable robot 1 according to the present disclosure may be configured to assist movement of the knee joint of the wearer. In this case, the above-mentioned rotary shaft A may be provided to face the knee joint of the wearer. In addition, the body link 100 may be provided to face a side of a thigh of the wearer based on the rotary shaft A, and the rotary link 200 may be provided to face a side of a calf of the wearer based on the rotary shaft A.

In some implementations, with reference to FIG. 6, the wearable robot 1 according to the present disclosure may be configured to assist movement of the hip joint of the wearer. In this case, the above-mentioned rotary shaft A may be provided to face the hip joint of the wearer. In addition, the body link 100 may be provided to face a side of an upper body of the wearer based on the rotary shaft A, and the rotary link 200 may be provided to face a side of a lower body of the wearer based on the rotary shaft A.

Various example implementations of the present disclosure have been described with reference to the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A joint device comprising:
a first link;
a second link rotatably coupled to the first link and configured to be rotatable about a rotary shaft; and
an elastic rod member having a first side coupled to the first link, and a second side coupled to the second link,
wherein the elastic rod member is configured to be elastically curved in conjunction with a rotational motion of the second link relative to the first link, and
wherein i) the first side of the elastic rod member is configured to be movably coupled to the first link to longitudinally move relative to the first link, or ii) the second side of the elastic rod member is configured to be movably coupled to the second link to longitudinally move relative to the second link.

2. The joint device of claim 1, wherein the second side of the elastic rod member is fixedly coupled to the second link, and the first side of the elastic rod member is configured to be movably coupled to the first link.

3. The joint device of claim 2, further comprising:
a guide member fixed to the first link and configured such that a part of the elastic rod member is inserted into the guide member,
wherein the elastic rod member is configured to longitudinally move relative to the guide member which is fixed on the first link.

4. The joint device of claim 3, further comprising:
an elasticity adjustment member configured to be adjustably positioned on the first link and movably coupled to the elastic rod member, and configured such that a part of the elastic rod member is inserted into the elasticity adjustment member,
wherein the elasticity adjustment member is configured to be adjustably positioned among a plurality of positions on the first link, and is configured to allow the elastic rod member to longitudinally move relative to the elasticity adjustment member and the first link.

5. The joint device of claim 4, wherein the elasticity adjustment member is adjustably positioned among the plurality of positions on the first link between (i) the first side of the elastic rod member which is movably coupled to the first link, and (ii) the second side of the elastic rod member which is fixedly coupled to the second link.

6. The joint device of claim 3, wherein the elastic rod member comprises a plurality of elastic rod members disposed in parallel.

7. The joint device of claim 4, wherein the elasticity adjustment member comprises a plurality of elasticity adjustment members, and
wherein the plurality of elasticity adjustment members are spaced apart from one another along a longitudinal direction of the elastic rod member.

8. The joint device of claim 6, further comprising:
a locking member provided at one side of the first link and configured to selectively allow or restrict a motion of the elastic rod member.

9. The joint device of claim 8, wherein at least a part of the locking member is provided in the guide member which is fixed on the first link.

10. A wearable robot comprising:
a joint device provided to face a joint of a wearer,
wherein the joint device comprises:
a body link;
a rotary link that is rotatably coupled to the body link and configured to be rotatable about a rotary shaft; and
an elastic rod member having a first side coupled to the body link, and a second side coupled to the rotary link,
wherein the elastic rod member is configured to be elastically curved in conjunction with a rotational motion of the rotary link relative to the body link, and
wherein i) the first side of the elastic rod member is configured to be movably coupled to the body link to longitudinally move relative to the body link, or ii) the second side of the elastic rod member is configured to be movably coupled to the rotary link to longitudinally move relative to the rotary link.

11. The wearable robot of claim 10, wherein the rotary shaft is provided to face an ankle joint of the wearer, the body link is provided to face a side of a leg of the wearer based on the rotary shaft, and the rotary link is provided to face a side of a foot of the wearer based on the rotary shaft.

12. The wearable robot of claim 10, wherein the rotary shaft is provided to face a knee joint of the wearer, the body link is provided to face a side of a thigh of the wearer based on the rotary shaft, and the rotary link is provided to face a side of a calf of the wearer based on the rotary shaft.

13. The wearable robot of claim 10, wherein the rotary shaft is provided to face a hip joint of the wearer, the body link is provided to face a side of an upper body of the wearer based on the rotary shaft, and the rotary link is provided to face a side of a lower body of the wearer based on the rotary shaft.

14. A joint device comprising:
a first link;
a second link rotatably coupled to the first link through a rotary shaft; and
an elastic rod member having a first side coupled to the first link, and a second side coupled to the second link,
wherein the elastic rod member is configured to be elastically curved in conjunction with a rotational motion of the second link relative to the first link,
wherein the first side of the elastic rod member is configured to be fixedly coupled to the first link, and
wherein the second side of the elastic rod member is configured to be movably coupled to the second link to allow longitudinal movement of the elastic rod member relative to the second link.
